(19) United States
(12) Patent Application Publication
(10) Pub. No.: US 2004/0215379 A1
(43) Pub. Date: Oct. 28, 2004

(54) Vehicle performance analyzer

(75) Inventors: Michael A. Pangerl, Zimmerman, MN (US); Richard L. Philips, Mound, MN (US)

Correspondence Address: NIKOLAI & MERSEREAU, P.A., 900 SECOND AVENUE SOUTH, SUITE 820, MINNEAPOLIS, MN, 55402, US

(73) Assignee: Vericom Compters Inc., Rogers, MN

(21) Appl. No.: 10/420,332

(22) Filed: Apr. 22, 2003

(51) Int. Cl. G06F 19/00

(52) U.S. Cl. 701/33; 701/29; 340/438

(57) ABSTRACT

A vehicle performance analyzer works in conjunction with the OBD-II system of a motor vehicle to assist mechanics in assessing and optimizing the performance of the motor vehicle. No separate accelerometer is required to determine performance parameters such as acceleration, distance, horsepower, torque or the gear ratio.

### BACKGROUND OF THE INVENTION

I. Field of the Invention

The present invention relates to equipment for analyzing the performance of a motor vehicle. More specifically, the present invention permits one to download data from a vehicle's onboard diagnostic computer (OBD) and use that data to assess the vehicle's performance.

II. Related Art

Vehicle performance analyzers are known in the prior art. An example is the Vericom 2000 made by the assignee of the present invention. The Vericom 2000 incorporates an accelerometer for measuring instantaneous acceleration and deceleration of a vehicle in which the unit is mounted. A computer uses these measurements to calculate velocity and distance by integrating the acceleration measurements. From those calculated parameters, a number of other performance related parameters can be computed such as the time required to travel from zero to sixty miles per hour, braking distance, horsepower, etc. The Vericom 2000 functions independently of any other computer equipment mounted on the motor vehicle. For its accelerometer to function correctly, the device must be leveled and balanced. This can be a somewhat tedious task.

During the 1970's and early 1980's, automobile manufacturers began to use electronic systems to monitor and control engine functions. These same systems were used to diagnose engine problems. In the early 1990's a new standard was introduced related to electronic engine control. This standard is referred to as the onboard diagnostic standard or OBD-II. OBD-II is an expanded set of standards and practices developed by the Society of Automotive Engineers. These standards and practices were adopted by the Environmental Protection Agency and the California Air Resources Board for implementation by Jan. 1, 1996.

As a result of these standards, all cars built since Jan. 1, 1996 have an OBD-II system incorporating a plurality of sensors. The brain of this system is an OBD-II computer. These OBD-II computers serve as a real-time data acquisition means used by the vehicle to collect information from the sensors and to display error messages. Mechanics use the OBD-II system to diagnose and address maintenance needs. All OBD-II computers have a standard connector that allows one to download data from the OBD-II computer into another device.

### SUMMARY OF THE INVENTION

The present invention replaces the VC2000 with a computer and an AutoTap scanner coupled to the vehicle's OBD-II connector. The software used in conjunction with the computer allows considerably more information to be derived relating to vehicle performance than can be obtained with the VC2000 system. The computer itself is preferably a portable computer such as a laptop or even a handheld style computer.

One type of data supplied by the OBD-II system is vehicle speed. The computer of the present invention uses this speed data to calculate a number of different parameters. First, by differentiating the speed, acceleration can be derived by the computer. Second, once acceleration, speed and a vehicle's weight are known, the computer can calculate horsepower. Third, by integrating speed, a distance can be derived. Fourth, once distance is known, the computer can access engine RPM data from the OBD-II system to measure the gear ratio. Fifth, engine torque can be derived from the calculated horsepower and RPM parameters.

Another advantage of the present invention is that the display of the computer can be used to display any number of sensor outputs generated by the OBD-II computer.

These and other advantages of the present invention will be made more clear from the following detailed description of the preferred embodiment and the accompanying drawings.

### BRIEF DESCRIPTION OF THE DRAWINGS

FIG. 1 is a block diagram of the present invention.

FIG. 2 is a flow chart showing the manner in which the computer of the present invention proved program options to the user.

FIG. 3 is a diagram showing the various types of information that is displayed when the invention is operating in its various modes.

FIG. 4 is a flow chart showing how the present invention operates in the 1 mile test mode.

FIG. 5 is a flow chart showing how the present invention operates in the real-time display mode.

FIG. 6 is a flow chart showing how the present invention operates in the scan tool mode.

FIG. 7 is a flow chart showing how the present invention operates in the calibrate speed mode.

FIG. 8 is a flow chart showing how the present invention operates in the display run data mode.

FIG. 9 is a diagram showing how the present invention can allow a user to select which data to be displayed from the various sensors of the OBD-II system when in the analyze data mode.

### DETAILED DESCRIPTION OF THE PREFERRED EMBODIMENT

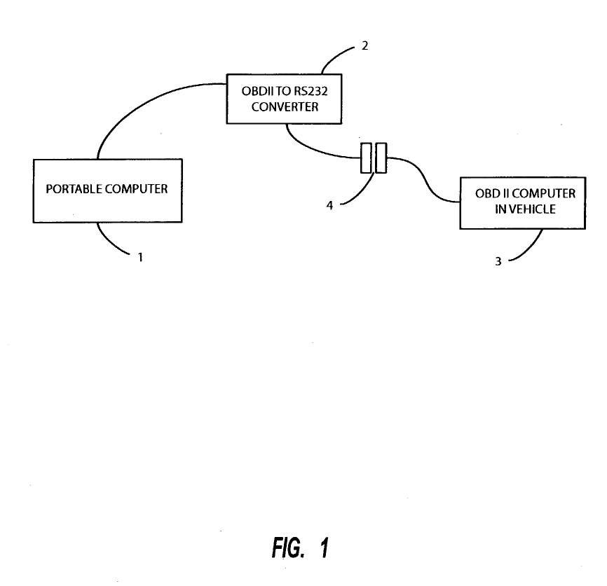

FIG. 1 shows a computer 1 coupled to a converter 2 which, in turn is coupled to the OBD-II computer 3 of a vehicle. The converter 2 can be any type of OBDII to RS232 converter marketed under the designation AutoTap. The converter 2 is coupled to the OBD-II computer 3 using the standard data port on all OBD-II computers. The computer 1 can be any general purpose computer. Preferably a portable computer such as a laptop or handheld computer is used. Any of a variety of well known data ports can be used to couple the converter 2 to the computer 1. The software of the present invention controls the computer 1 to provide the desired functions.

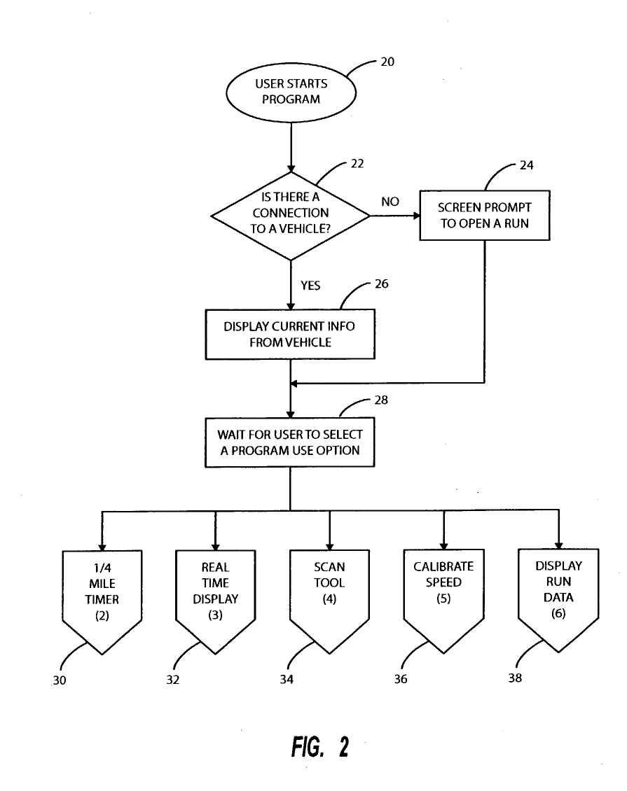

When the software program of the present invention is launched, the subroutine shown in FIG. 2 is run. On program start up 20, the computer 1 looks to see if there is a data connection to the vehicle at step 22. If not, the user is prompted via screen prompt 24 to open such a connection. If a connection exists, the current information from the OBD-II system is displayed at step 26. The system then waits at step 28 for the user to select from five different options 30-38 respectively.

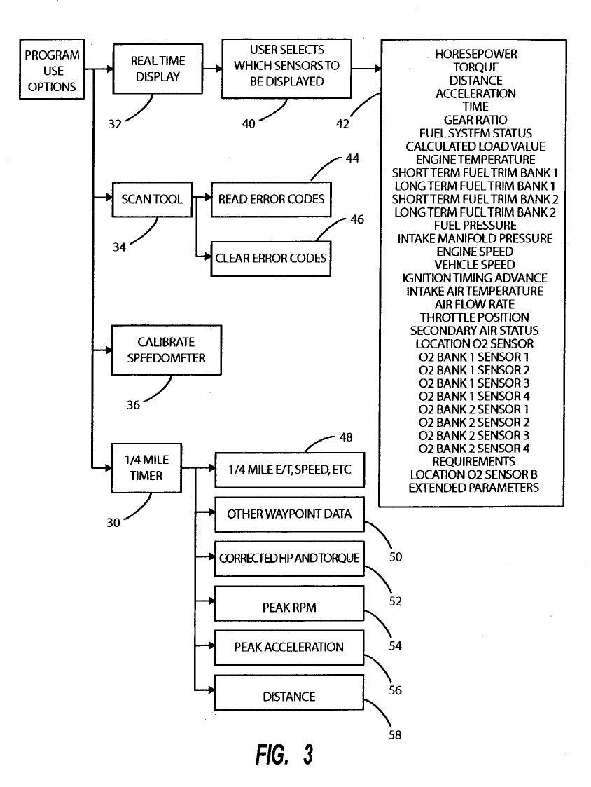

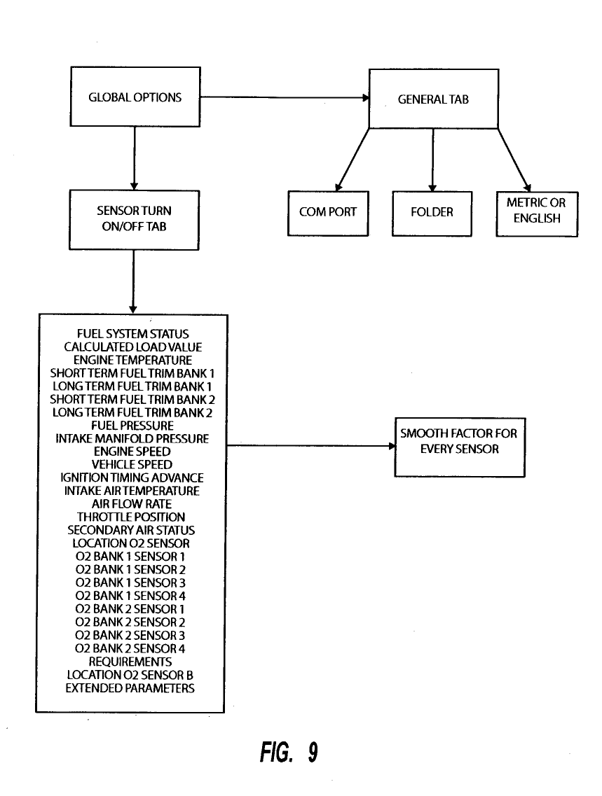

FIG. 3 shows the different types of data that are derived and displayed by the system in the various modes of operation. For example, when the user selects the real-time display mode 32, the user can allow the computer 1 to display all of the data collected by the OBD-II computer 3 from the various sensors that comprise the OBD-II system. Alternatively, at step 40, the user can select which types of data 42 to display. Display of such data enables the user to diagnose problems or tune the vehicle's operation to improve performance. FIG. 9 shows the options available as part of the set up of the system to time various sensors on and off and identify where data is stored and the types of units used.

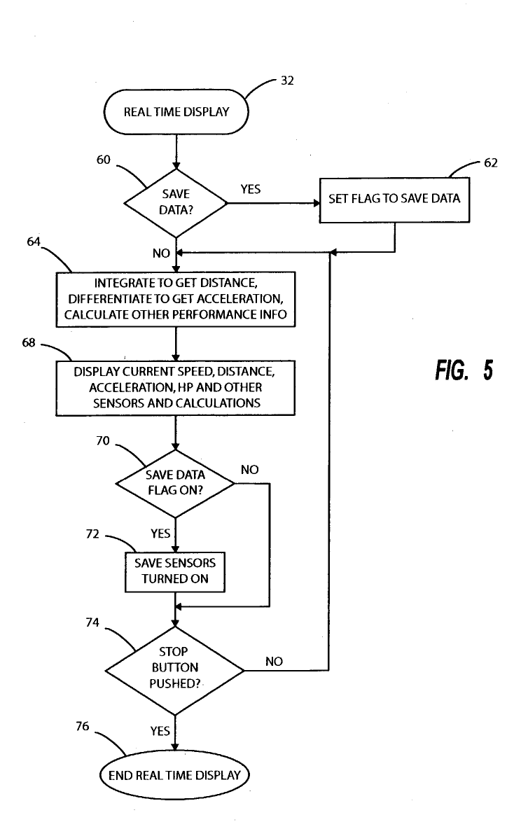

FIG. 5 shows the operation of computer 1 when in the real-time display mode. At step 40, the user can decide whether to store the data as it is generated while in the real-time display mode or merely display the data in real-time. If the user desires to store the data, the flag 62 is set. In either case, the computer 1 uses the real-time data computer 1 collected from the OBD-II computer to determine distance, acceleration and other performance information at step 64. At step 68, the results of these calculations are displayed. Displayed information includes current speed, distance, acceleration, horsepower as well as other sensor data and calculations. The system then checks at step 70 to see if the flag has been set at 62. If so, the computer 1 saves the data from the sensors 42 selected by the user at step 40. The subroutine then continues to recycle through steps 64-74 until it is determined at step 74 that the stop button has been pushed at which time the system exits the real-time display subroutine at step 76.

The OBD-II computer 3 also has the capacity to process the data received from the sensors and cause the warning lights on the vehicle's dashboard to illuminate. These warning lights advise a driver when there is a problem with the vehicle, but do not provide a detailed description of the nature of the problem detected. For example, the OBD-II computer 3 will illuminate the “check engine” light on the dash of a car in response to a number of different detected considerations. To provide service personnel with detailed information regarding the type of problem, the OBD-II computer 3 stores error codes describing the reasons for illumination of the dashboard warning lights. When the computer 1 of the present invention is in the scan tool mode 34, it can download and display these error codes at step 44. The computer 1 can also send signals to the OBD-II computer 3 to clear the error codes at step 46. The error codes might be cleared by a mechanic for any number of reasons. When the problem is fixed, the code should be cleared so the warning light on the dash is no longer illuminated. Also, the mechanic may wish to clear the code for test purposes to see if the condition that caused the error will repeat itself.

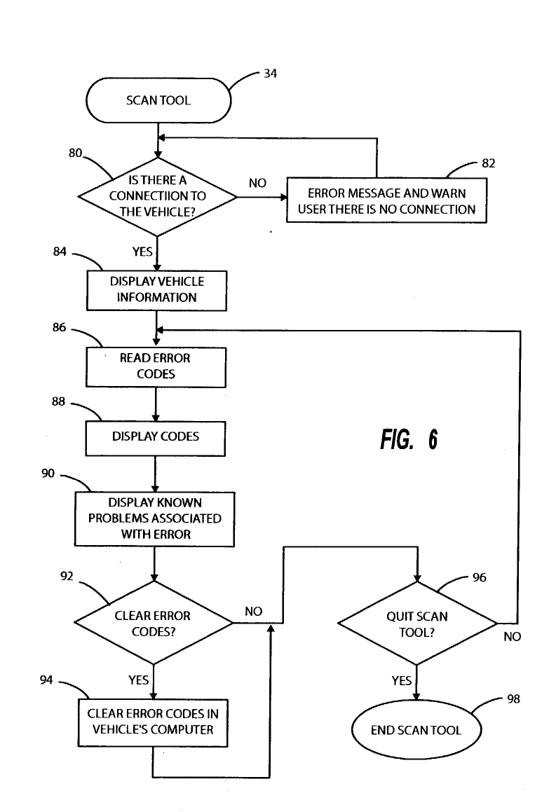

FIG. 6 is a flow chart of the scan tool subroutine. After the computer 1 enters the scan tool subroutine at step 34, it proceeds to step 80 to see if there is a connection to the vehicle. If not, an error message is displayed at step 82 advising that such a connection must be made. If a connection has been made, the computer 1 proceeds to step 84 and displays information related to the vehicle such as the vehicle's identification number. Next, the program moves to step 86 where computer 1 reads the error codes from the OBD-II computer 3. At step 88 the error codes are displayed. To assist the user, the computer 1 has been programmed to include information related to known problems associated with each error code. At step 90, the known problems associated with the error code are displayed. At step 92, the user is prompted to indicate whether the error codes should be cleared. If the user indicates the error codes should be cleared, at step 94 the computer 1 instructs the OBD-II computer to clear the codes. In either case the user is asked whether to exit the scan tool mode at step 96. If the answer is no, the software recycles through steps 86-96 until the user chooses to exit the scan tool mode at step 96. The software then advances to step 98 and returns to the main menu.

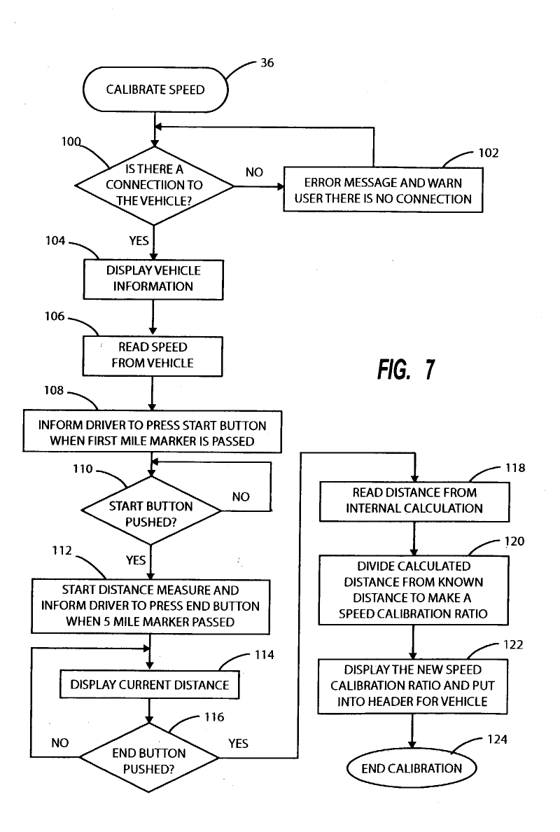

The manner in which the computer 1 operates in the calibrate speed mode will now be described with reference to FIG. 7. When one chooses to enter the calibrate speed mode at step 36, the software proceeds to step 100 where the computer 1 determines whether the computer 1 is connected via the scanner to the OBD-II computer 3. If there is no connection, the computer 1 generates an error message at step 102. If there is a connection, the software advances to step 104 and displays vehicle information (such as the vehicle identification number) stored in the OBD-II computer. Next, the software advances to step 106 and reads the speed from the vehicle. At step 108, the user is instructed to press the start button as a mile marker on the side of the road is passed. The software then continuously cycles through step 110 until activation of the start button is detected indicating the first mile marker has been reached. At step 112, the computer starts to measure distance and instructs the driver to push the end button at the 5 mile marker. The software then continuously cycles through steps 114 and 116 until the end button is actuated. The computer continuously updates the distance traveled from the point where the start button was actuated until actuation of the end button is detected.

At this point, the computer has two pieces of distance data—the distance it calculated had been traveled between the actuation of the start button and the actuation of the end button, and the five miles reflected by the mile markers used by the user in actuating the start and end buttons. At step 118 the computer 1 reads the distance from its internal calculation. At step 120, the computer 1 divides the distance it calculated by five miles to make a speed calibration ratio. The new speed calibration ratio is displayed at step 122 and put into a header for the vehicle. The software at step 124 then exits the calibration mode. The header can be used either to calibrate the vehicle's speedometer or alternatively, it can be used to perform other calculations made by computer 1 to increase the accuracy of those calculations.

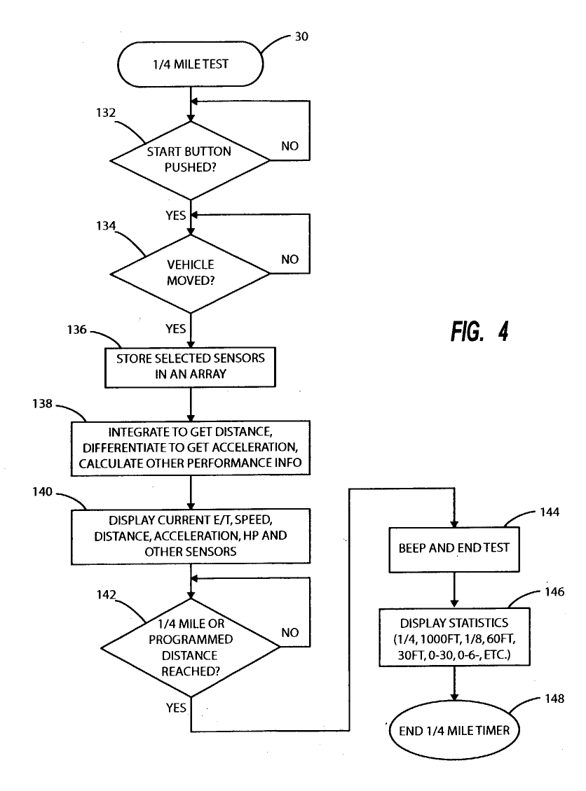

Using the system of the present invention, a number of calculations related to vehicle performance can be made in the ¼ mile test mode 30. This mode of operation will be described with reference to FIG. 4. When the ¼ mile test mode is entered, the computer ¼ cycles through step 132 until the start button is actuated. The computer 1 then cycles through step 134 until the vehicle begins to move. Once motion of the vehicle is detected, the computer 1 begins to store sensor data retrieved in real time from the OBD-II computer 3. Next, the computer 1 uses various items of retrieved data at step 138 to calculate other performance parameters. For example, the computer 1 integrates speed data to determine distance. The computer also differentiates the speed data to determine acceleration. Other information calculated at step 138 includes horsepower, torque, and gear ratio. Horsepower is calculated in accordance with the following formula:

Horsepower=Speed×Acceleration×Vehicle Weight×K

K is a constant that equals

$$\frac{1.46667}{550} .$$

Once horsepower has been calculated, it is possible to calculate torque. The following formula is used:

$$\frac{Torque = Horsepower \times 5252.113}{Revolutions Per Minute}$$

The value for revolutions per minute (RPM) is obtained from the OBD-II system. The computer 1 can also calculate the gear ratio by distance in feet by revolutions per minute (RPM).

At step 140, the computer 1 displays the current elapsed time since the vehicle started moving, the vehicle's speed, the distance traveled, acceleration, horsepower and any of a variety of selectable data obtained from the OBD-II computer 3. The software continues to cycle through steps 136-142 constantly refreshing the display until either a ¼ mile or some other programmed distance is reached. When this occurs, the computer 1 issues an audible indication of the end of the test at step 144. At step 146, the computer displays selected performance information (calculated by the computer 1 or simply retrieved from the OBD-II computer) related to various points during the test; i.e. 30 feet into the test, 60 feet into the test, ⅛ mile into the test, 1000 feet into the test and ¼ mile into the test. The computer 1 can also display the elapsed time to accelerate from zero to 30 miles per hour or zero to 60 miles per hour. Other data can be displayed as desired. The system exits the 1/4 mile test mode at step 148.

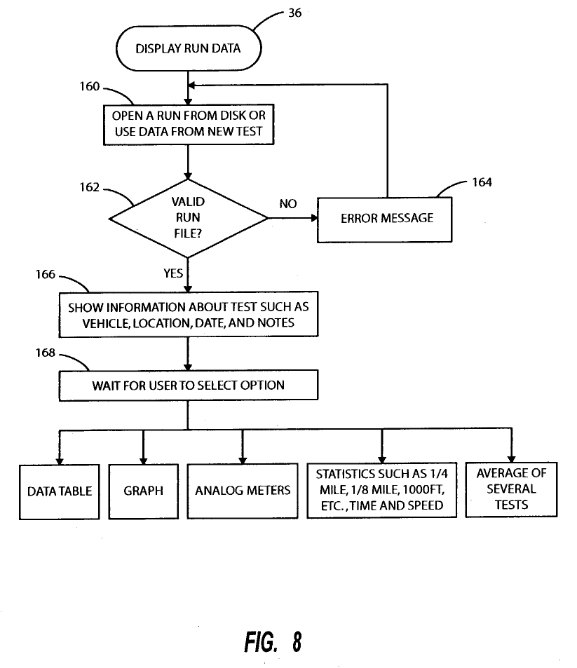

FIG. 8 describes the operation of the system in the “display run data” mode 38. In this mode, the user at step 160 selects data stored on disc collected during an earlier run or use data from a new test run. At step 162 the computer verifies whether a valid run file has been selected. if not, an error message is generated at step 164. Assuming a valid run file has been selected, at step 66 the computer displays various information related to the data in the file and waits at step 168 until the user selects the format in which the data is to be displayed. The system allows the user to display the data in a table form, a graph form, or with representations of analog meters. The user can also display various selectable statistics related to a run. the system also allows the user to display the averages derived from several tests.

Those skilled in the art will recognize the powerful nature of the present invention, its use as a diagnostic tool, and the ability of a skilled mechanic to optimize vehicle performance based upon information provided through use of the present invention.

What is claimed is:

1. A method for analyzing the performance of a motor vehicle equipped with an onboard diagnostic system capable of storing data related to the vehicle, monitoring the speed of the vehicle, monitoring the condition of a plurality of sensors, and producing digital signals representative of stored data related to the vehicle, the speed of the vehicle and the condition of said sensors, comprising the steps of:
a. downloading a set of said digital signals to a computer;
b. using said computer to process said digital signals representative of the process speed of the vehicle to determine a first operating parameter of the vehicle; and
c. displaying said operating parameter.

2. The method of claim 1 wherein said operating parameter is acceleration.

3. The method of claim 1 wherein said operating parameter is distance traveled.

4. The method of claim 2 further including the step of using said first operating parameter and other of said digital signals to calculate and display a second operating parameter.

5. The method of claim 4 wherein said first operating parameter is acceleration and said second operating parameter is horsepower.

6. The method of claim 4 wherein said first operating parameter is distance, said other of said digital signals is representative of revolutions per minute, and said second operating parameter is the gear ratio.

7. The method of claim 5 further including the step of calculating engine torque based upon horsepower and a digital signal representative of revolutions per minute.

8. For analyzing the performance of a motor vehicle equipped with an onboard diagnostic system capable of storing data related to the vehicle, monitoring the speed of the vehicle, monitoring the condition of a plurality of sensors, and producing digital signals representative of stored data related to the vehicle, the speed of the vehicle and readings from said sensors; a method comprising the steps of:
a. downloading said digital signals to a computer;
b. using said computer
i. to integrate digital signals representative of the speed of the vehicle to calculate distance;
ii. differentiate digital signals representative of the speed of the vehicle to calculate acceleration; and
iii. displaying said calculated distance and said calculated acceleration.

9. The method of claim 8 further including the step of calculating and displaying gear ratio.

10. The method of claim 8 further including the step of calculating and displaying horsepower.

11. The method of claim 8 further including the step of calculating and displaying engine torque.
